(19) United States
(12) Patent Application Publication
(10) Pub. No.: US 2020/0034755 A1
(43) Pub. Date: Jan. 30, 2020

(54) VEHICLE RESERVATION SYSTEM, VEHICLE RESERVATION METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 16/458,347

(22) Filed: Jul. 1, 2019

(30) Foreign Application Priority Data
Jul. 24, 2018 (JP) 2018-138086

(51) Int. Cl. G06Q 10/02; G06F 16/29; G06F 16/9537; G01C 21/34; G01C 21/36

(52) U.S. Cl. CPC G06Q 10/02; G06F 16/29; G01C 21/3667; G01C 21/3407; G06F 16/9537

(57) ABSTRACT

A vehicle reservation system includes an information processing apparatus and a server. The server includes a server storage unit that, acquires and stores a plurality of activity schedules as schedule information in association with the user, an information extraction unit that extracts, from the schedule information, a first location and a transport included in a first activity schedule, and a reservation unit that reserve the transport. The information extraction unit extracts, from the schedule information, a second location and an end time of the time range included in a second activity schedule that takes place immediately prior to the first activity schedule, as a place of departure and a time of departure to travel to the first location. The reservation unit outputs the first location as a destination, the place of departure and the time of departure to an administrator of the transport.

### INCORPORATION BY REFERENCE

The disclosure of Japanese Patent Application No. 2018-138086 filed on Jul. 24, 2018 including (he specification, drawings and abstract is incorporated herein by reference in its entirety.

### BACKGROUND

### 1. Technical Field

The present disclosure relates to a vehicle reservation system, a vehicle reservation method, and a non-transitory storage medium storing a program.

### 2. Description of Related Art

Conventionally, a system in which a user can reserve a vehicle using a terminal device is known. For example, Japanese Unexamined Patent Application Publication No. 2004-110758 (JP 2004-110758 A) discloses a technology in which a taxi dispatch center combines, with map information, position information transmitted from a taxi terminal and a user terminal, and transmits the result to the user terminal, and the user subsequently selects one of a plurality of taxis on a map and requests dispatching of taxis.

### SUMMARY

Here, according to a system described in JP 2004-110758 A. when a user desires the dispatching of taxis, the user is required to execute an operation for the dispatching of taxis (for example, a connection to the taxi dispatch center, selection of a taxi) using the user terminal. In other words, in the system described in JP 2004-110758 A, a vehicle reservation is not automatically executed according to the user's schedule (user's activity schedule).

For example, Japanese Unexamined Patent Application Publication No. 2004-078702 (JP 2004-078702 A) discloses a system that automatically requests a reservation of transportation facilities, or the like, on behalf of a user, at an appropriate timing according to the user's schedule. However, the user is required to register in advance the transportation facilities, or the like, as a reservation target. In other words, in the system described in JP 2004-078702 A, the user is required to specify and input candidate facilities for reservation, such as transportation facilities. For example, when the user travels in a place that he or she is visiting for the first time, the user is required to check in advance the name of the candidate facilities, such as transportation facilities, or the like. For this reason, the automatic reservation system disclosed in JP 2004-078702 A imposes an input burden on the user.

For example, Japanese Unexamined Patent Application Publication No. 2004-185494 (JP 2004-185494 A) discloses a system that executes an automatic reservation of a taxi, or a cancellation of the automatic reservation of the taxi, according to the user's railway use situation. In addition, Japanese Unexamined Patent Application Publication No. 2004-304354 (JP 2004-304354 A) discloses a system that executes automatically reserved operations of devices, such as home appliances, based on the schedules of a plurality of family members. However, the technology disclosed in JP 2004-185494 A is a system that requires provision of information from an automatic ticket gate machine at a railway, and thus cannot cope with flexibility in a user's schedule (for example, when die user travels to a place in which travel by railway is not available). Moreover, the technology disclosed in JP 2004-304354 A is a system for the reserved operation of home appliances that are shared among family members, and thus it is difficult for the system to be applied to transportation facilities or the like.

The present disclosure provides a vehicle reservation system, a vehicle reservation method, and a non-transitory storage medium storing a program, capable of reducing a user's input burden, and automatically executing a vehicle reservation according to the user's activity schedule.

A vehicle reservation system according to a first aspect of the present disclosure includes an information processing apparatus into which a user can input, as an activity schedule, a time range, a location, and a transport to travel to the location, and a server that can communicate with the information processing apparatus. The server includes a server storage unit that acquires a plurality of activity schedules and stores the plurality of activity schedules as schedule information in association with the user, an information extraction unit that extracts, from the schedule information, a first location and a transport included in a first activity schedule, and a reservation unit that reserves the transport. The information extraction unit extracts, from the schedule information, a second location and an end time of a time range included in a second activity schedule that takes place immediately prior to the first activity schedule, as a place of departure and a time of departure to travel to the first location. The reservation unit reserves the transport with an administrator of the transport by outputting the first location as a destination, the place of departure, and the lime of departure to the administrator.

The server may include a route search unit that searches for a first route from the place of departure to a boarding position of the transport acquired from the administrator, and an information update unit that generates a map showing the first route and causes the information processing apparatus to display the map.

The route search unit may further search for a second route from the boarding position to the destination, and calculate an estimated time of arrival at the destination. The information update unit may cause the information processing apparatus to display at least one of the estimated time of arrival, a name of the administrator of the transport, and a transportation fee.

A vehicle reservation method according to a second aspect of the present disclosure is executed by a server of a vehicle reservation system that includes an information processing apparatus into which a user can input, as an activity schedule, a time range, a location, and a transport to travel to the location, and the server that can communicate with the information processing apparatus. The vehicle reservation method includes a step of acquiring a plurality of activity schedules and storing the plurality of activity schedules as schedule information in association with the user, a step of extracting, from the schedule information, a first location and a transport included in a first activity schedule, a step of extracting, from the schedule information, a second location and an end time of the time range included in a second activity schedule dial takes place immediately prior to the first activity schedule, as a place of departure and a time of departure to travel to the first location, and a step of reserving the transport with an administrator of the transport by outputting the first location as a destination, the place of departure, and the time of departure to the administrator.

A non-transitory storage medium according to a third aspect of the present disclosure stores a program that causes a server of a vehicle reservation system to execute a process. The vehicle reservation system includes an information processing apparatus into which a user can input, as an activity schedule, a time range, a location, and a transport to travel to the location, and the server that can communicate with the information processing apparatus. The process includes a step of acquiring a plurality of activity schedules and storing the plurality of activity schedules as schedule information in association with the user, a step of extracting, from the schedule information, a first location and a transport included in a first activity schedule, a step of extracting, from the schedule information, a second location and an end time of a time range included in a second activity schedule that takes place immediately prior to the first activity schedule, as a place of departure and a time of departure to travel to the first location, and a step of reserving the transport with an administrator of the transport by outputting the first location as a destination, the place of departure and the time of departure to the administrator.

With the vehicle reservation system, vehicle reservation method, and non-transitory storage medium storing the program according to each aspect of the present disclosure, a user's input burden can be reduced, and a vehicle reservation can be automatically executed according to the user's activity schedule.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating an example of a schematic configuration of a vehicle reservation system;

FIG. 2 is a diagram illustrating an example of a schematic configuration of an external server communicating with die vehicle reservation system;

FIG. 3 is a diagram illustrating an example of a schedule registration screen;

FIG. 4 is an example of a sequence diagram when a transport is a taxi;

FIG. 5 is a diagram illustrating an example of a schedule display screen;

FIG. 6 is a diagram illustrating an example of the schedule display screen after completion of a reservation;

FIG. 7 is an example of a sequence diagram when the transport is a shared vehicle;

FIG. 8 is a diagram illustrating another example of the schedule display screen;

FIG. 9 is a diagram illustrating another example of the schedule display screen after the completion of the reservation;

FIG. 10 is a diagram illustrating another example of the schedule registration screen; and

FIG. 11 is a diagram illustrating yet another example of the schedule display screen.

### DETAILED DESCRIPTION OF EMBODIMENTS

Hereinafter, an embodiment of the present disclosure will be described with reference to the drawings. In each of the drawings described below, the same reference numerals are given to the parts having the same configuration, and redundant descriptions may be omitted.

### Vehicle Reservation System

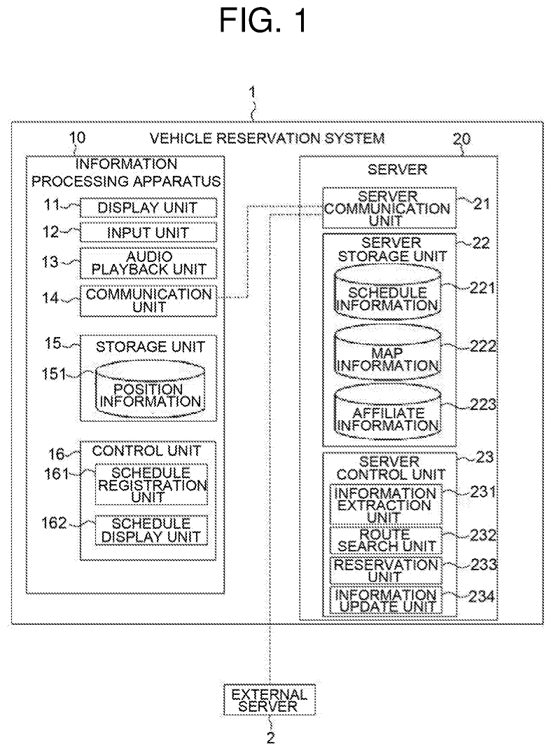

FIG. 1 is a diagram illustrating a schematic configuration of a vehicle reservation system 1 according to one embodiment of the present disclosure. The vehicle reservation system 1 includes an information processing apparatus 10 and a server 20. In the present embodiment, the information processing apparatus 10 is a mobile information terminal carried and used by a user. The mobile information terminal is, for example, a smartphone. Here, the information processing apparatus 10 is not limited to the smartphone. Examples of the information processing apparatus 10 may include a tablet terminal, or other devices used by the user. The server 20 may include one or a plurality of server devices that can communicate with one another. In the present embodiment, the server 20 is installed, for example, in an information center that collects and analyzes information on a vehicle. The server 20 can communicate with the information processing apparatus 10. Further, the server 20 can communicate with an external server 2. Here, the vehicle reservation system 1 may include a plurality of information processing apparatuses 10. In such a case, the server 20 can communicate with each of the plurality of information processing apparatuses 10. in addition, the server 20 can communicate with an in-vehicle device mounted on one or more vehicles in order to collect information on the vehicles.

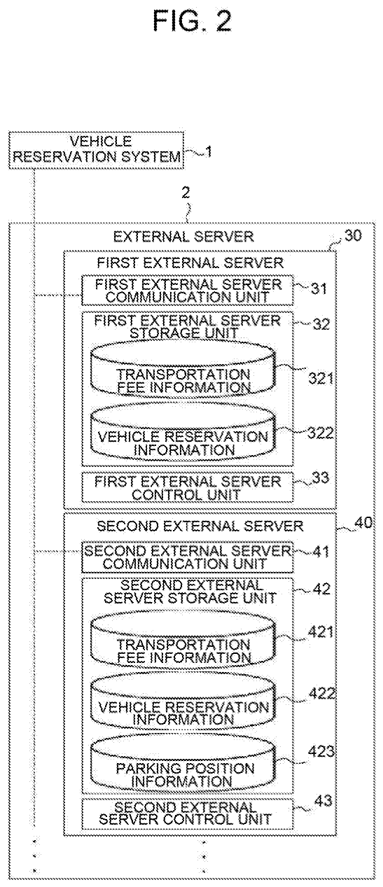

The external server 2 is an example of an administrator that manages a vehicle, and can include a server device. As illustrated in FIG. 2, in the present embodiment, the external server 2 includes a first external server 30 that manages dispatching of taxis, and a second external server 40 that manages shared or rental vehicles. The server 20 outputs information necessary for a reservation to the first external server 30 or the second external server 40, and executes a reservation of a vehicle. Here, the external server 2 may further include another server device. Furthermore, the external server 2 may include only one server device. In other words, the number of server devices included in the external server 2 is not limited.

Here, as described above, the server 20 is connected to each of the information processing apparatus 10 and the external server 2, so as to be able to communicate with them via a network. The network includes, for example, the Internet, but may include any other network. For example, the network may include wired communication and wireless communication. Examples of a wireless communication standard include mobile communication standards such as 2G to 5G, Long Term Evolution (LTE), worldwide interoperability for microwave access (WiMAX), IEEE 802.11, Bluetooth®, infrared data association (IrDA), and near field communication (NFC).

### Information Processing Apparatus

As illustrated in FIG. I, the information processing apparatus 10 includes a display unit U, an input unit 12. an audio playback unit 13, a communication unit 14, a storage unit 15. and a control unit 16.

The display unit 11 includes a display that displays information. Examples of the display may include a flat panel display, such as a liquid crystal panel and an organic electro luminescence (EL) panel. In the present embodiment, the information processing apparatus 10 includes a touch panel display in which the display unit 11 and the input unit 12 are integrated with each other.

The input unit 12 includes one or more input interfaces that receive an input of the user. In the present embodiment, the input unit 12 is a touch panel installed integrally with the display unit 11. Here, another example of the input unit 12 may be a keyboard that receives a text input, or a microphone that receives a voice input. Yet another example of the input unit 12 may include two or more of a touch panel, a keyboard, and a microphone.

The audio playback unit 13 includes one or more speakers. The audio playback unit 13 may play, for example, audio to provide route guidance to reach a destination.

The communication unit 14 includes one or more communication interfaces. The communication unit 14 may include, for example, a communication interface corresponding to each of the mobile communication standard, the wired local area network (LAN) standard, the wireless LAN standard, and the like.

Further, the communication unit 14 receives a signal (a global positioning system (GPS) signal) from a GPS satellite. Based on the GPS signal, position information 151 of the information processing apparatus 10 can be calculated.

The storage unit 15 includes one or more memories. Examples of the memory may include a semiconductor memory, a magnetic memory, and an optic memory. Each memory included in the storage unit 15 may function as. for example, a primary storage device, a secondary storage device, or a cache memory. The storage unit 15 stores any information used for an operation of the information processing apparatus 10. In the present embodiment, the storage unit 15 stores the position information 151. The position information 151 is used to show a current position of the information processing apparatus 10 on a map, when the map is displayed on a schedule display screen (to be described below). Further, the storage unit 15 may store map information and audio information used to provide route guidance to reach the destination. In addition, the storage unit 15 may store, for example, an identification (ID) to specify a user of the information processing apparatus 10.

The control unit 16 includes one or more processors. Examples of the processor may include a general-purpose processor, and a processor dedicated to a specific processing. For example, the control unit 16 may be a central processing unit (CPU). The control unit 16 controls overall operation of the information processing apparatus 10. In the present embodiment, the control unit 16 includes a schedule registration unit 161 and a schedule display unit 162. Moreover, the control unit 16 can calculate the position information 151 based on the GPS signal. The calculated position information 151 is stored in the storage unit 15.

The schedule registration unit 161 executes a registration processing by acquiring, from the input unit 12, an activity schedule that the user has input on a schedule registration screen, and transmitting the activity schedule to the server 20. Here, the schedule registration screen is a screen displayed to allow the user to input each activity schedule item. The activity schedule transmitted from the schedule registration unit 161 to the server 20 is registered by being stored as schedule information 221 (to be described below). Here, the schedule registration unit 161 also transmits the ID to the server 20. so that the activity schedule can be stored in association with the user.

The schedule display unit 162 causes the display unit 11 to display the schedule registration screen and the schedule display screen. Here, the schedule display screen displays the activity schedule of a registered user as a list. The schedule display unit 162 acquires, via the communication unit 14, the activity schedule of the registered user from the schedule information 221 (to be described below).

The schedule registration screen and the schedule display screen may be displayed during an execution of an application program installed in the information processing apparatus 10. The application program is, for example, a schedule management program. The application program is downloaded via the communication unit 14 and stored in the storage unit 15. Then, the application program is executed by a predetermined operation of the user (for example, by tapping an icon, or the like). The schedule registration screen or the schedule display screen may be displayed by the user's designating a specific item in the menu of the application program. In addition, the schedule registration screen or the schedule display screen may be displayed by the user's tapping a notification (for example, a push notification) displayed on the touch panel display of the information processing apparatus 10. Further, the schedule registration screen or the schedule display screen may be displayed at a predetermined time, without requiring the user's operation. For example, when the content of the activity schedule is modified, a push notification may be transmitted from the server 20 to the information processing apparatus 10. The schedule display screen including the modified activity schedule may be displayed by the user's tapping the push notification. Further, for example, after the user completes an input on the schedule registration screen, the schedule display screen may be automatically displayed so that the user can confirm the content.

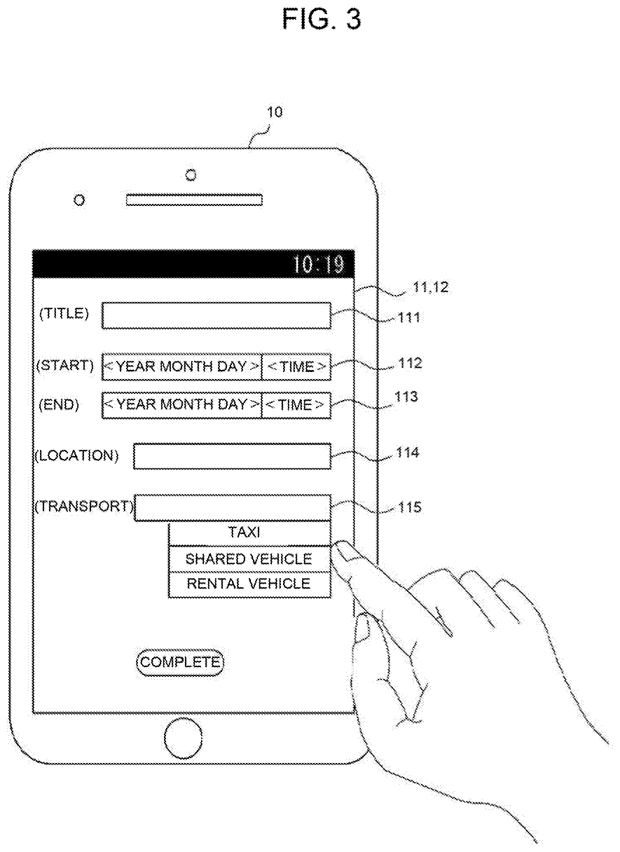

Here, FIG. 3 illustrates an example of the schedule registration screen. The schedule registration screen is displayed on the touch panel display of the information processing apparatus 10 that is, for example, a smartphone. The user can input, for example, a time range, a location, and a transport to travel to the location, as an activity schedule, on the schedule registration screen. In the example of FIG. 3, the user can input a title of the activity schedule into a title input area 111. The title may be, for example, a meeting name such as “YYYY Meeting”. Further, the user can input a start time of the activity schedule into a start time input area 112. Moreover, the user can input an end time of the activity schedule into an end time input area 113. In the present embodiment, the lime may further include a year, a mouth, and a day. In addition, the user can input a location (for example, a meeting location in the example of the meeting above) into a location input area 114. Further, the user can select the transport in a transport input area 115. In the present embodiment, one of “taxi”, “shared vehicle”, and “rental vehicle” is selected as the transport. When the user inputs or selects the above items and executes a completion operation (for example, taps a completion button), a process of registering the activity schedule proceeds. A detailed example of the schedule display screen will be described below.

### Server

As illustrated in FIG. 1, the server 20 includes a server communication unit 21, a server storage unit 22, and a server control unit 23.

The server communication unit 21 includes one or more communication interfaces. The server communication unit 21 may include, tor example, a communication interface corresponding to each of the wired LAN standard, the wireless LAN standard, and the like.

The server storage unit 22 includes one or more memories. Examples of the memory include a semiconductor memory, a magnetic memory, or an optic memory. Each memory included in the server storage unit 22 may function as, for example, a primary storage device, a secondary storage device, or a cache memory. The server storage unit 22 stores any information used for an operation of the server 20.

In the present embodiment, the server storage unit 22 stores the schedule information 221, map information 222, and affiliate information 223. The server 20 manages the schedule information 221, the map information 222, and the affiliate information 223 by, for example, updating, deleting, or modifying the data.

The schedule information 221 includes one or more activity schedules. The schedule information 221 stores the activity schedule acquired by the server 20 in association with the user of the information processing apparatus 10 that transmitted the activity schedule. Here, the server control unit 23 specifies the user based on the ID that is transmitted from the information processing apparatus 10 together with the activity schedule. The schedule information 221 can accumulate the schedules (the activity schedules) of each of one or more users.

The map information 222 is information on a map used in a route guidance service. The route guidance service searches for a route to the destination, and displays the route. The map is, for example, a road map. In the present embodiment, the map information 222 includes traffic information that can be reflected on the map. Examples of the traffic information include information on a traffic congestion occurrence and a road closure due to roadwork.

Here, as described above, the server 20 can communicate with each of the in-vehicle devices mounted on one or more vehicles. For example, the server 20 can acquire information on a traffic congestion occurrence (an example of the traffic information) based on the position information, or the like, of a travelling vehicle. Further, based on such traffic information, the server 20 can recognize a tendency of traffic congestion on a specific road (for example, a tendency of traffic congestion on weekday evenings), and reflect the tendency in the map information 222. By using the map information 222, which includes traffic information based on information from travelling vehicles, the server 20 can estimate an accurate time of arrival, and can provide the route guidance service capable of recommending an appropriate route. Further, the information processing apparatus 10 can access the schedule information 221 and the map information 222. For example, the information processing apparatus 10 can display the schedule display screen by using the data of the schedule information 221. Further, for example, the information processing apparatus 10 can display a map screen that provides route guidance to reach the destination, using the data of the map information 222.

The affiliate information 223 is information on the external server 2 that the server 20 instructs to reserve a vehicle. In the present embodiment, the affiliate information 223 stores access information (for example, an address on the Internet, or the like) to the external server 2 in association with a transport available for reservation. For example, access information to a first external server 30 (see FIG. 2) is stored in the affiliate information 223 in association with the “taxi”, which is one type of transport. Further, for example, access information to the second external server 40 (sec FIG. 2) is stored in the affiliate information 223 in association with “shared vehicle” or “rental vehicle”, which is another type of transport.

The server control unit 23 includes one or more processors. Examples of the processor may include a general-purpose processor and a processor dedicated to a specific process. For example, the server control unit 23 may be a CPU. The server control unit 23 controls overall operation of the server 20. In the present embodiment, the server control unit 23 includes an information extraction unit 231, a route search unit 232, a reservation unit 233, and an information update unit 234.

After the activity schedule of the user is registered, the information extraction unit 231 extracts, from the schedule information 221, the location and transport in the registered activity schedule. Here, it is considered that one activity schedule is registered by the input of the user (see FIG. 3), and it is referred to as a “first activity schedule”. In addition, it is considered that the location included in the first activity schedule is referred to as a “first location”. The information extraction unit 231 extracts, from the schedule information 221, the location and lime range included in the activity schedule that takes place immediately prior to the first activity schedule. Here, the activity schedule that takes place immediately prior to the first activity schedule is referred to as a “second activity schedule”, and the location included in the second activity schedule is referred to as a “second location”. In addition, the time range is determined by the start time and the end time of the activity schedule.

Here, the first activity schedule is scheduled to follow the second activity schedule. The user needs to travel from the second location to the first location. In addition, the user can start travelling at the end time of the second activity schedule. The information extraction unit 231 outputs the extracted first location to the route search unit 232 and the reservation unit 233, as the destination of travel. Further, the information extraction unit 231 outputs the extracted second location to the route search unit 232 and the reservation unit 233, as a place of departure of travel. Moreover, the information extraction unit 231 outputs the end time of the time range of the extracted second activity schedule to the route search unit 232 and the reservation unit 233, as a time of departure of travel.

Further, the information extraction unit 231 extracts the transport of the first activity schedule from the schedule information 221 The information extraction unit 231 outputs the extracted transport to (he reservation unit 233. In addition, the information extraction unit 231 may extract the time range of the first activity schedule from the schedule information 221. The information extraction unit 231 may output a start lime of the time range included in die first activity schedule to the route search unit 232, as a time of completion of travel.

The route search unit 232 searches for a route to the destination. The route search unit 232 searches for the route to the destination by using information on the destination of travel (the first location), place of departure (the second location), and time of departure (the end time included in the second activity schedule) of travel, and calculates an estimated time of arrival at the destination. When the estimated time of arrival at the destination is later than the time of completion of travel (the start time of the first activity schedule), the route search unit 232 may execute the search for die route to the destination again. The route search unit 232 outputs, to the reservation unit 233, the route and estimated time of arrival at the destination.

Further, as will be described below, when a boarding position of the transport is different from the place of departure, the route search unit 232 searches for a route from the place of departure to the boarding position of the transport, and a route from the boarding position to the destination of travel. Here, the route from the place of departure to the boarding position of the transport is referred to as a first route. Further, the route from the boarding position to the destination of travel is referred to as a second route. Here, the first route and the second route become a new route to the destination. Further, when the route search unit 232 searches for the first route and the second route, the route search unit 232 also recalculates the estimated time of arrival at the destination. Here, the user travels along die first route using a transport other than a vehicle (for example, walking and public transportation). The route search unit 232 outputs, to the information update unit 234, the route and estimated time of arrival at the destination.

The reservation unit 233 reserves the transport. Based on the affiliate information 223, the reservation unit 233 acquires the information to access the external server 2 in association with the transport acquired front the information extraction unit 231. The reservation unit 233 outputs, to the external server 2, information on the destination, place of departure, and time of departure of travel, and instructs the external server 2 to reserve the transport. Further, the reservation unit 233 may output, to the external server 2. the route and estimated time of arrival acquired from the route search unit 232. In the present embodiment, the reservation unit 233 accesses the server device of an administrator that manages one of a plurality of servers (for example, the first external server 30 and the second external server 40) included in the external server 2, and instructs the server device to execute the reservation.

In addition, the reservation unit 233 acquires a response (reservation information) to the reservation instruction from the external server 2. In the present embodiment, the reservation unit 233 acquires the administrator's name and the transportation fee as reservation information. Here, the administrator's name may be, for example, a company name or an organization name. Here, the administrator's name may be determined based on the affiliate information 223, instead of being acquired from the external server 2. Further, the reservation information may include information on a boarding position or information on a parking lot (to be described below). In addition, the reservation information may include information indicating completion (success) of (he reservation or failure of the reservation. When the reservation unit 233 acquires the information indicating that the reservation has failed, the reservation unit 233 may access the server device of another administrator based on the affiliate information 223, and instruct the server device to execute the reservation. The reservation unit 233 outputs the administrator's name and the transportation fee to the information update unit 234. Further, the reservation unit 233 can output the information of the boarding position or the information of the parking lot to the route search unit 232 and the information update unit 234.

The information update unit 234 manages the schedule information 221, the map information 222. and the affiliate information 223. For example, when the user inputs or modifies the activity schedule on the schedule registration screen, the information update unit 234 executes a process of causing the input or modified activity schedule to be reflected in the schedule information 221. Further, when the information update unit 234 acquires, from the route search unit 232, the route and estimated time of arrival at the destination, the information update unit 234 executes the process of causing the route and estimated time of arrival to be reflected in the schedule information 221. Here, the information update unit 234 may generate a map showing the route based on the map information 222, and include the map in the schedule information 221. The map showing the route may include, for example, a map showing a route from the place of departure to the boarding position of the transport (a first route). In addition, when the information update unit 234 acquires the administrator's name and the transportation fee from the reservation unit 233, the information update unit 234 executes the process of causing the administrator's name and the transportation fee to be reflected in the schedule information 221. Furthermore, when the information update unit 234 acquires new traffic information (for example, a road closure due to roadwork) via the server communication unit 21, the information update unit 234 executes the process of causing the new traffic information to be reflected in the map information 222. Further, when the information update unit 234 acquires a change of affiliate via the server communication unit 21, the information update unit 234 executes the process of causing the change of the affiliate to be reflected in the affiliate information 223.

In addition, when the information update unit 234 updates the schedule information 221, the information update unit 234 transmits a notification to the information processing apparatus 10 via the server communication unit 21 to prompt the information processing apparatus 10 to update the schedule display screen. When the schedule management application program is running in the information processing apparatus 10, the application program may automatically access the schedule information 221, and display the schedule display screen in response to the notification. The notification may include, for example, a push notification. Here, by the user's tapping the push notification, the information processing apparatus 10 may access the updated schedule information 221.

Here, as described above, when the reservation is completed by the external server 2, the information update unit 234 causes, the map showing the generated route, estimated time of arrival, administrator's name, and transportation fee to be reflected in the schedule information 221. In other words, the information update unit 234 can cause the information processing apparatus 10 to display at least one of the map showing the generated route, estimated lime of arrival, administrator's name, and transportation fee.

### External Server

The external server 2 manages a vehicle of the transport. As described above, in the example of FIG. 2, the external server 2 includes the first external server 30 that manages dispatching of taxis, and the second external server 40 that manages shared or rental vehicles.

For example, the first external server 30 may be installed at a dispatch management center at Company C, a taxi company. The first external server 30 can communicate with the server 20. As illustrated in FIG. 2, the first external server 30 includes a first external server communication unit 31, a first external server storage unit 32, and a first external server control unit 33.

The first external server communication unit 31 includes one or more communication interfaces. The first external server communication unit 31 may include, for example, a communication interface corresponding to each of the wired LAN standard, the wireless LAN standard, and the like.

The first external server storage unit 32 includes one or more memories. Examples of the memory may include a semiconductor memory, a magnetic memory, and an optic memory. Each of the memories included in the first external server storage unit 32 may function as, for example, a primary storage device, a secondary storage device, or a cache memory. The first external server storage unit 32 stores any information used for an operation of the first external server 30.

The first external server storage unit 32 stores, for example, transportation fee information 321 and vehicle reservation information 322. The transportation fee information 321 is information on a taxi fare, and includes, for example, information on a transportation fee calculated according to travelling distance and travelling hours. Further, the vehicle reservation information 322 is information showing the reservation state of the taxi, and includes, for example, information on the number and vehicle types of taxis available for reservation for each date and time.

The first external server control unit 33 acquires, from the server 20, the information on the destination, place of departure, and time of departure of travel, and the reservation instruction. In addition, the first external server control unit 33 may further acquire the route and estimated time of arrival determined by the server 20. The first external server control unit 33 may select a taxi available for reservation based on, for example, the information on the destination, place of departure, and time of departure of travel, and the vehicle reservation information 322, and specify the vehicle type of taxi. Here, instead of the vehicle type of taxi, information on the maximum number of passengers may be specified. Furthermore, the first external server control unit 33 may calculate the transportation fee based on, for example, the information on the route, time of departure, and estimated time of arrival, and the transportation fee information 321. Further, when the place of departure cannot be set as the boarding position of the taxi, the first external server control unit 33 selects an appropriate boarding position Here, when the first external server control unit 33 does not acquire the route and estimated time of arrival determined by the server 20, the first external server control unit 33 may independently search for a route and calculate an estimated time of arrival

When the first external server control unit 33 has completed the reservation of the taxi, the first external server control unit 33 outputs the administrator's name (for example. Company C) and the transportation fee for the reserved taxi to the server 20. In addition, when the place of departure is different from the boarding position of the taxi, the first external server control unit 33 outputs the information on the boarding position to the server 20.

Further, for example, the second external server 40 may be installed at a vehicle management center of Company D, a vehicle sharing or rental company. The second external server 40 can communicate with the server 20. As illustrated in FIG. 2. the second external server 40 includes a second external server communication unit 41, a second external server storage unit 42, and a second external server control unit 43.

The second external server communication unit 41 includes one or more communication interfaces. The second external server communication unit 41 may include, tor example, a communication interface corresponding to each of the wired LAN standard, the wireless LAN standard, and the like.

The second external server storage unit 42 includes one or more memories. Examples of the memory may include a semiconductor memory, a magnetic memory, and an optic memory. Each of the memories included in the second external server storage unit 42 may function as, for example, a primary storage device, a secondary storage device, or a cache memory. The second external server storage unit 42 stores any information used for an operation of the second external server 40.

The second external server storage unit 42 stores, for example, transportation fee information 421, vehicle reservation information 422. and parking position information 423. The transportation fee information 421 is information on a charge for using a shared or rental vehicle, and includes, for example, information on a transportation fee calculated according to travelling distance and travelling hours. Further, the vehicle reservation information 422 is information indicating the reservation state of the shared or rental vehicle, and includes, for example, information on the number and types of vehicles available for reservation for each date and time. In addition, the parking position information 423 is information on a parking position of the shared or rental vehicle. In the case of the shared vehicle, the parking position information 423 includes, for example, address information of a parking lot to which a shared vehicle is contracted. Further, in the case of the rental vehicle, the parking position information 423 includes, for example, address information of a parking lot of a vehicle rental office to which a rental vehicle is returned.

The second external server control unit 43 acquires, from the server 20, the information on the destination, place of departure, and time of departure of travel, and the reservation instruction. In addition, the second external server control unit 43 may additionally acquire the route and estimated time of arrival determined by the server 20. The second external server control unit 43 may select a vehicle that is available for reservation and is parked near the place of departure based on, for example, the information on the destination, place of departure, and lime of departure of travel, the vehicle reservation information 422. and the parking position information 423, and specify the type of the vehicle. Furthermore, the second external server control unit 43 may calculate the transportation fee based on, for example, the information on the route, time of departure, and estimated time of arrival, the specified type of vehicle, and the transportation fee information 421. Here, when the transportation fee changes depending on the time when the vehicle is returned, the second external server control unit 43 may acquire, from the server 20, for example, the hours of use, and calculate the transportation fee. In addition, in the ease of the shared or rental vehicle, unlike the case of the taxi, in many cases the place of departure cannot be set as the boarding position. In other words, the user is required to travel to the parking lot of the reserved vehicle. The second external server control unit 43 sets the parking lot of the vehicle as the boarding position. Here, when the second external server control unit 43 does not acquire the route and estimated time of arrival determined by the server 20, the second external server control unit 43 may independently search for a route and calculate an estimated time of arrival.

When the second external server control unit 43 has completed the reservation of the shared or rental vehicle, the second external server control unit 43 outputs the administrator's name (for example. Company D), the transportation fee, and the boarding position of the reserved vehicle to the server 20. In addition, the second external server control unit 43 may output the type of the reserved vehicle to the server 20.

### Communication Process

The vehicle reservation system 1 according to the present embodiment automatically executes die vehicle reservation according to the user's activity schedule by executing a communication process (a vehicle reservation method) (to be described below).

### First Communication Process

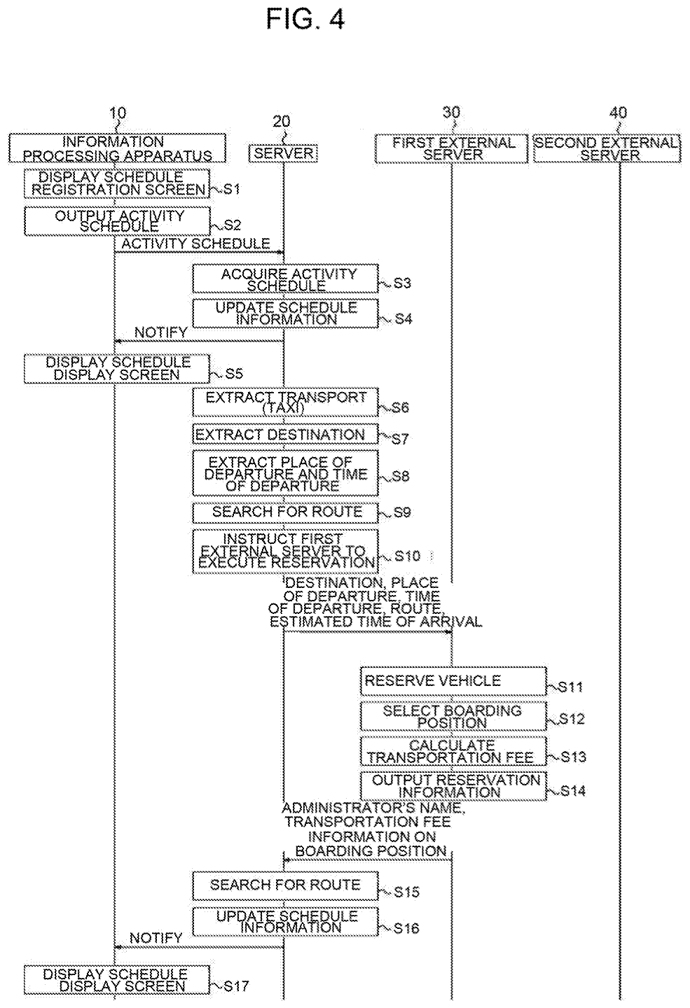

FIG. 4 illustrates a communication process (a first communication process) when the transport is a taxi. The information processing apparatus 10 activates the schedule management application program according to a predetermined operation of the user (for example, tapping an icon or the like). The information processing apparatus 10 displays the schedule registration screen by, for example, the user's designating a specific item in the menu of the schedule management application program (step S1). As illustrated in FIG. 3, the schedule registration screen is, for example, a screen on which the user inputs his or her activity schedule.

When the user inputs each item in the activity schedule, the information processing apparatus 10 outputs the user's activity schedule to the server 20 (step S2). Here, as illustrated in FIG. 3, the user's activity schedule includes the transport to travel to the location in addition to the time range (the start time and the end time) and location. In the present embodiment, the transport refers to the type of the vehicle used for travel, and specifically, to a taxi, a shared vehicle, or a rental vehicle.

The server 20 acquires the user's activity schedule from the information processing apparatus 10 (step S3). Here, the server 20 keeps in storage the schedule information 221 that is a database of the schedule management application program described above. The server 20 stores the acquired activity schedule in the schedule information 221 in association with the user of the information processing apparatus 10. In other words, the server 20 updates the schedule information 221 (step S4). Updating the schedule information 221 in step S4 corresponds to registering the acquired activity schedule. Here, the activity schedule acquired by the server 20 corresponds to the first activity schedule described above.

The server 20 outputs, to the information processing apparatus 10, a notification indicating that the schedule information 221 has been updated Upon receiving the notification, the schedule management application program running in the information processing apparatus 10 automatically accesses the updated schedule information 221, and displays the schedule display screen (step S5).

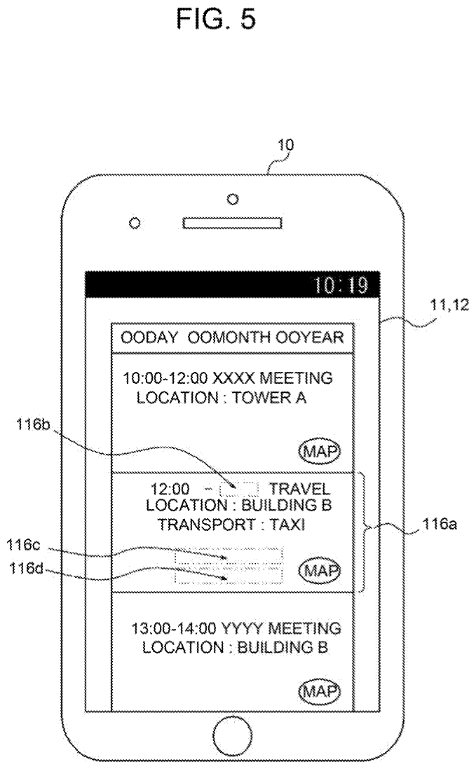

FIG. 5 illustrates an example of the schedule display screen. The schedule display screen shows the user's activity schedule. In the example of FIG. 5, the schedule display screen shows the first activity schedule of one day (YYYY Meeting to be held in Building B at 13:00-14:00). In addition, the schedule display screen shows the second activity schedule (XXXX Meeting to be held at Tower A at 10:00-12:00) that takes place immediately prior to the first activity schedule, and a travelling schedule 116a (travelling to Building B by taxi after 12:00). Here, the travelling schedule 116a is automatically set by the information processing apparatus 10 or the server 20. In other words, the travelling schedule 116a is not input by the user. For example, the schedule management application program running in the information processing apparatus 10 may determine that the location of the first activity schedule is different from the location of the second activity schedule, and automatically set the travelling schedule 116a.

As illustrated in FIG. 5, when the reservation has not been completed, the travelling schedule 116a does not include the estimated time of arrival 116b, the administrator's name 116c, and the transportation tee 116d on the schedule display screen. In other words, when the reservation has not been completed, although the schedule display screen displays the time of departure (12:00), destination (Building B), and transport (taxi) of travel for confirmation by the user, the estimated time of arrival 116b, the administrator's name 116c, and the transportation fee 116d remain blank. Here, the schedule display screen includes an image (a MAP button), to display a map of each of the locations in the first activity schedule, the travelling schedule 116a, and the second activity schedule. In the example of FIG. 5, a map including a location of Building B is displayed on the schedule display screen by the user's tapping the MAP button of the travelling schedule 116a.

After outputting, to the information processing apparatus 10, a notification indicating that the schedule information 221 has been updated, the server 20 extracts the transport from the information in the user's first activity schedule included in the schedule information 221 (step S6). In the example of FIG. 4, the transport is a taxi.

In addition, the server 20 extracts the destination (for example. Building B) from the information in the user's first activity schedule included in the schedule information 221 (step S7). Further, the server 20 extracts the place of departure and time of departure from the information in the user's second activity schedule included in the schedule information 221 (step S8). The server 20 sets the location (for example, Tower A) included in the second activity schedule as the place of departure. In addition, the server 20 sets the end time (for example, 12:00) included in the second activity schedule as the time of departure to travel to the destination. Here, the server 20 may set the time of departure by adding a break lime (for example, 10 minutes) lo the end time. The break time may be adjusted by the user.

The server 20 searches for the route to the destination using the extracted information on the destination, place of departure, and time of departure, and calculates the estimated lime of arrival at the destination (step S9). The server 20 outputs the information on the destination, place of departure, and time of departure to the first external server 30, and instructs the first external server 30 to execute the reservation (step S10). In the present embodiment, the server 20 also outputs, to the first external server 30, the route and estimated time of arrival at the destination.

The first external server 30 reserves the taxi (step S11), selects the boarding position (step S12), and calculates the transportation fee (step S13), using the information on the destination, place of departure, time of departure, route, and estimated time of arrival acquired from the server 20, as described above. The boarding position is selected when it is not possible for the user to board the taxi at the place of departure. In other words, if it is possible for the user to board the taxi at the place of departure, step S12 can be omitted.

The first external server 30 outputs the reservation information to the server 20 (step S14). The reservation information includes the information on the administrator's name, transportation fee, and boarding position. Here, when the reservation of the taxi has not been made, the first external server 30 may output, as the reservation information, information indicating failure of the reservation. For example, when the server 20 acquires the information indicating that the reservation has failed, the server 20 may select a server device of another administrator based on the affiliate information 223. Then, the processing of steps S10 to S14 may be executed between the server 20 and the other administrator's server device.

When the boarding position is different from the place of departure, the server 20 re-searches for a route to the destination and recalculates an estimated time of arrival at the destination (step S15). When the boarding position is the same as the place of departure, the server 20 may proceed to step S16 without executing the processing of step S15. Here, the re-search for the route to the destination is executed for the first route, from the place of departure to the boarding position of the taxi, and the second route, from the boarding position to the destination, respectively. As described above, a transport other than a vehicle is used for the first route.

The server 20 updates the schedule information 221 so that the estimated time of arrival, the administrator's name, and the transportation fee arc added to the information in the user's first activity schedule (step S16). Further, when the boarding position is different from the place of departure, the server 20 updates the schedule information 221 so that the boarding position is also added to the information in the user's first activity schedule.

The server 20 outputs, to the information processing apparatus 10, a notification indicating that the schedule information 221 has been updated. Upon receiving the notification, the schedule management application program running in the information processing apparatus 10 automatically accesses the schedule information 221, and displays the schedule display screen (step S17). Here, when the schedule management application program is not running in the information processing apparatus 10, the schedule display screen may be displayed by the users tapping a push notification indicating an update of the schedule information 221.

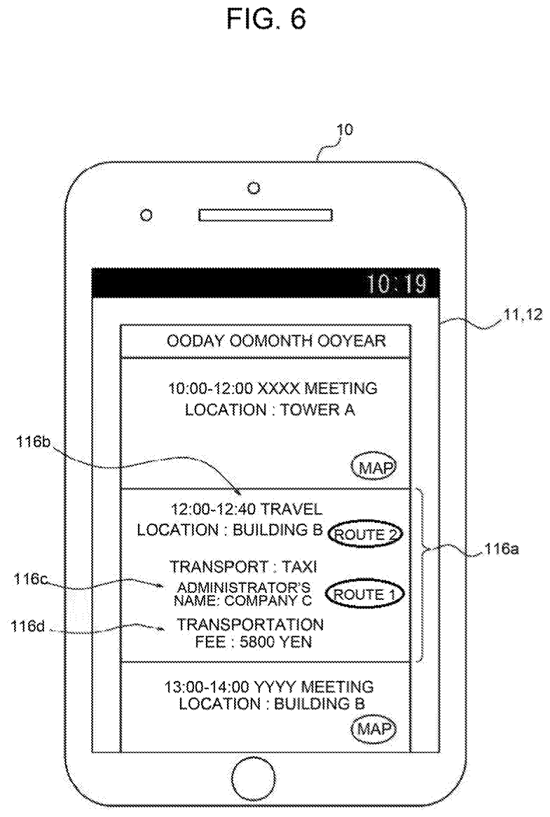

FIG. 6 illustrates an example of the schedule display screen after completion of the reservation. As illustrated in FIG. 6, the schedule display screen after completion of the reservation includes the estimated time of arrival 116b (12:40), the administrator's name 116c (Company C), and the transportation fee 116d (5800 yen). In other words, unlike the schedule display screen before completion of the reservation (see FIG. 5), the content of the estimated time of arrival 116b, administrators name 116c, and transportation fee 116d are added to the schedule display screen after completion of the reservation.

Further, instead of the MAP button, two images (a first route button and a second route button) are displayed to display maps showing the routes in the travelling schedule 116a. In the example of FIG. 6, a map including the first route, from the place of departure to the boarding position of the taxi, is displayed by the user's tapping the first route button. In addition, a map including the second route, from the boarding position to the destination, is displayed by the user's tapping the second route button.

### Second Communication Process

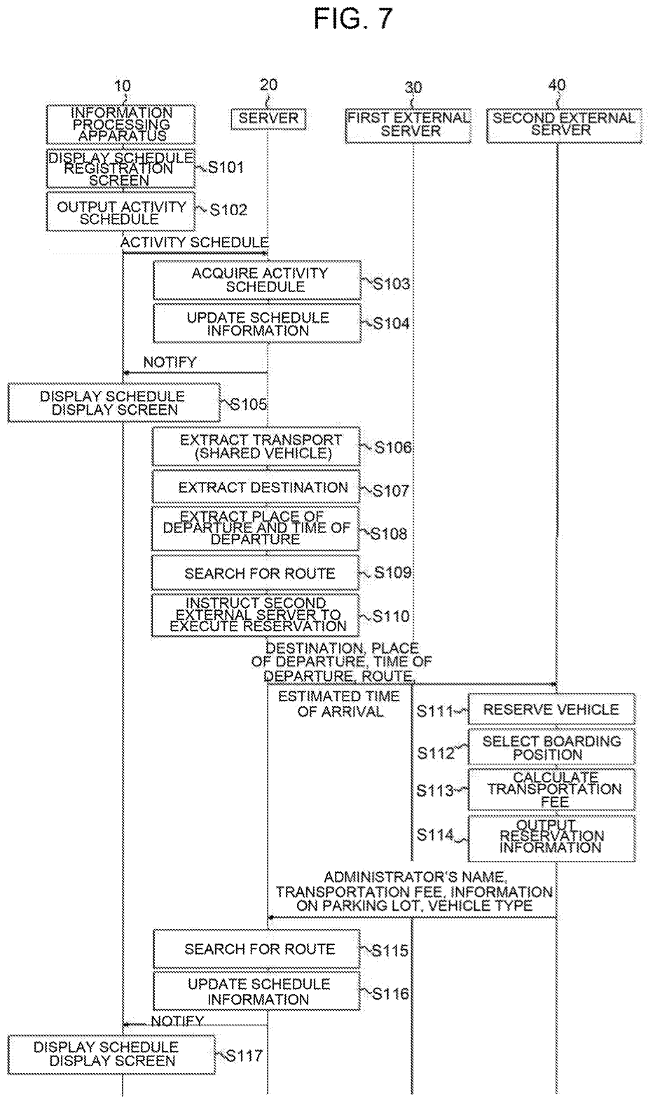

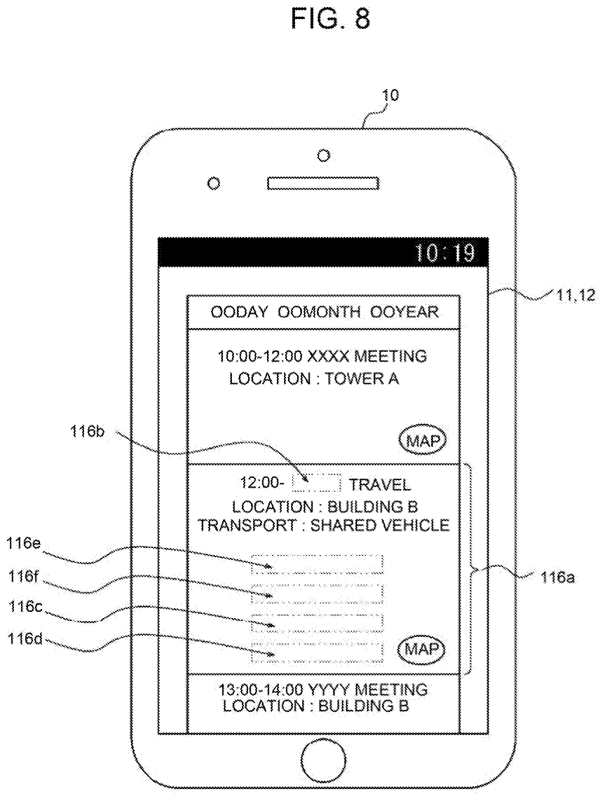

FIG. 7 illustrates a communication process (second communication process) when the transport is a shared vehicle. The communication process when the transport is a rental vehicle is executed in the same manner as the second communication process. Furthermore, the processing of steps S101 to S110 is the same as the processing of the respective steps S1 to S10 of the first communication process. For this reason, a description on the processing of steps S101 to S110 is omitted. However, in step S106, the transport extracted by the server 20 is not a taxi but a shared vehicle. In addition, FIG. 8 is an example of the schedule display screen displayed by the schedule management application program running in the information processing apparatus 10 in step S105.

As illustrated in FIG. 8, when the reservation has not been completed, the travelling schedule 116a does not include the estimated time of arrival 116b, the administrator's name 116c, the transportation fee 116d, the parking lot 116c at which the reserved vehicle is parked, and the type of reserved vehicle 116f on the schedule display screen. In other words, when the reservation has not been completed, although the schedule display screen displays the time of departure (12:00), destination (Building B), and transport (shared vehicle) of travel for confirmation by the user, the estimated time of arrival 116b, the administrator's name 116c. the transportation fee 116d, the parking lot 116e, and the type of vehicle 116f remain blank.

As illustrated in FIG. 7. after the server 20 instructs the second external server 40, which is the server device of the administrator of the shared vehicle, to execute the reservation (step S110), the second external server 40 executes processing of the vehicle reservation.

The second external server 40 reserves the shared vehicle (step S111), selects the parking lot (step S112), and calculates the transportation fee (step S113), using the information on the destination, place of departure, time of departure, route, and estimated time of arrival acquired from the server 20, as described above. The parking lot may, for example, be selected from among the parking lots at which available vehicles are parked according to the distance from die place of departure.

The second external server 40 outputs the reservation information to the server 20 (step S114). The reservation information includes the information on the administrator's name, the transportation fee, and the parking lot. The reservation information may further include the information on the type of vehicle. Here, the type of vehicle is the type of the vehicle that the second external server 40 has reserved. The type of vehicle may refer to, for example, a model name of the vehicle. In addition, the type of vehicle may refer to a classification of the vehicle (for example, a small family car, or the like). Further, the type of vehicle may refer to a classification of a transportation fee of the vehicle (for example, a compact type, or the like). Here, when the vehicle reservation has failed, the second external server 40 may output, as the reservation information, information indicating failure of the reservation. For example, when the server 20 acquires the information indicating that the reservation has failed, the server 20 may select a server device of another administrator based on the affiliate information 223. Then, the processing of steps S110 to S114 may be executed between the server 20 and the other administrator's server device.

The server 20 re-searches for a route to the destination and recalculates an estimated time of arrival at the destination (step S115). Here, the re-search for the route to the destination is executed for the first route, from the place of departure to the parking lot, and the second route, from the parking lot to the destination, respectively. As described above, a transport other than a vehicle is used for the first route.

The server 20 updates the schedule information 221 so that the estimated time of arrival, the administrator's name, the transportation fee. and the parking lot are added to the information in the user's first activity schedule (step S116). Further, when the type of vehicle is included in the reservation information, the server 20 updates the schedule information 221 so that the type of vehicle is also added to the information in the user's first activity schedule.

The server 20 outputs, to the information processing apparatus 10, a notification indicating that the schedule information 221 has been updated. Upon receiving lite notification, the schedule management application program running in the information processing apparatus 10 automatically accesses the schedule information 221, and displays the schedule display screen (step S117). Here, when the schedule management application program is not running in die information processing apparatus 10. the schedule display screen may be displayed by the user's tapping a push notification indicating an update of the schedule information 221.

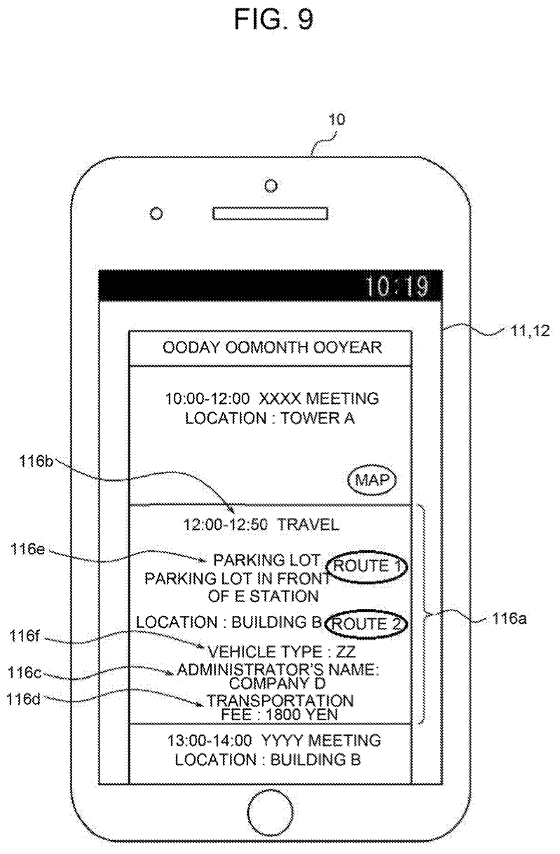

FIG. 9 illustrates an example of the schedule display screen after completion of the reservation. As illustrated in FIG. 9, the schedule display screen after completion of the reservation includes the estimated time of arrival 116b (12:50). the administrator's name 116c (Company D), the transportation fee 116d (1800 yen), the parking lot 116e (parking lot in front of E station), and the type of vehicle 116f (ZZ). In other words, unlike the schedule display screen before completion of the reservation (see FIG. 8), the content of the estimated lime of arrival 116b. the administrator's name 116c, the transportation fee 116d, the parking lot 116e, and the type of vehicle 116f are added to the schedule display screen after completion of the reservation.

Further, instead of (he MAP button, two images (a first route button and a second route button) are displayed to maps showing the routes on the travelling schedule 116a. In the example of FIG. 9, a map including the first route, from the place of departure to the boarding position (the parking lot) of the vehicle, is displayed by the user's tapping the first route button. In addition, a map including the second route, from the parking lot to the destination, is displayed by the user's tapping the second route button.

As described above, with the above configuration, the vehicle reservation system 1 can automatically execute the vehicle reservation according to the user's activity schedule. In addition, the user is not required to specify and input, in advance, candidate facilities as a reservation target, such as transportation facilities, or the like, as in the related art. As in the above embodiment, the user is required, for example, to merely input the activity schedule on the schedule management application program. Further, for example, even though the user does not input the place of departure, the vehicle reservation system 1 can automatically execute the vehicle reservation by extracting the place of departure from the schedule information 221 and setting the extracted place of departure as the place of departure for the vehicle reservation. Therefore, the vehicle reservation system 1 can reduce the user's input burden, compared to the related art.

In addition, as in the above embodiment, the vehicle reservation system 1 can display the first route, from the place of departure to the boarding position of the transport, on a map. Therefore, the user can easily reach the boarding position. Furthermore, as in the above embodiment, the vehicle reservation system 1 can display at least one of the estimated time of arrival, the name of the administrator of transport, and the transportation fee. Therefore, the user can easily understand the details of the activity schedule.

The present disclosure was described above with reference to the drawings and the embodiment. However, it is to be noted that a person skilled in the an can easily make variations and modifications thereto, based on the present disclosure. Therefore, it is also to be noted that these variations and modifications fall within the scope of the present disclosure. For example, functions, and the like, included in each element, each step, or the like, can be rearranged so as not to be logically contradictory, and a plurality of elements, steps, or the like, may be combined into one or divided.

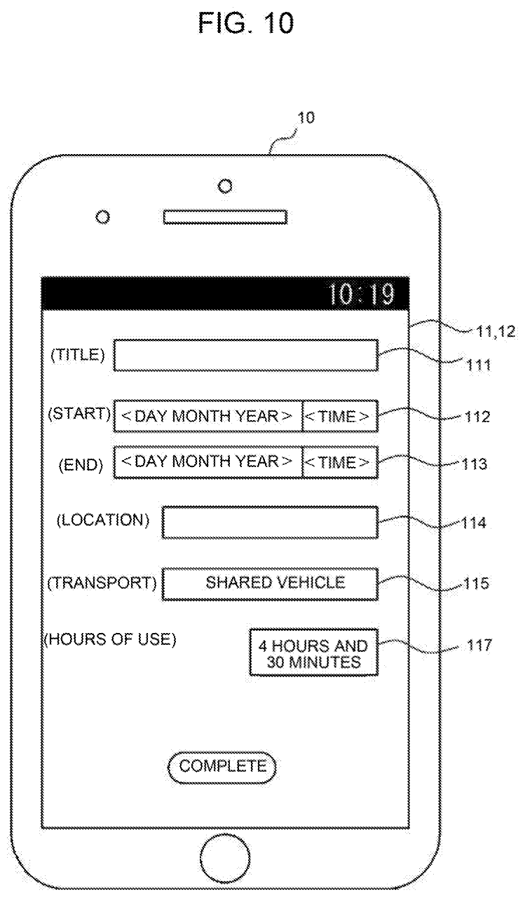

For example, in the above embodiment, the route search unit 232 may search for a different route depending on the transport, in addition, when the route search unit 232 searches for a different route depending on the transport, the items to be input on the schedule registration screen may change. FIG. 10 illustrates an example of the schedule registration screen displayed when the route search unit 232 searches for a different route depending on the transport. In the example of FIG. 10, when the user selects a shared or rental vehicle as the transport, an item of “hours of use” is added to the schedule registration screen. In the case of the shared or rental vehicle, the hours of use refers to a period between the time of starting to use the vehicle and the time when the vehicle is returned. For example, as illustrated in FIG. 10, if the period between the time of starting to use the vehicle and the time of starting the next activity schedule is 4 hours and 30 minutes, the user inputs 4 hours and 30 minutes.

The vehicle reservation system I executes the processing of steps S101 to S114 of FIG. 7 in the same manner as in the above-described second communication process. When re-searching for the route to the destination in step S115, the server 20 also searches for a route by which to return the vehicle within the hours of use. Here, the server 20 may acquire from the second external server 40, as the reservation information, information on the parking lot to which to return the vehicle.

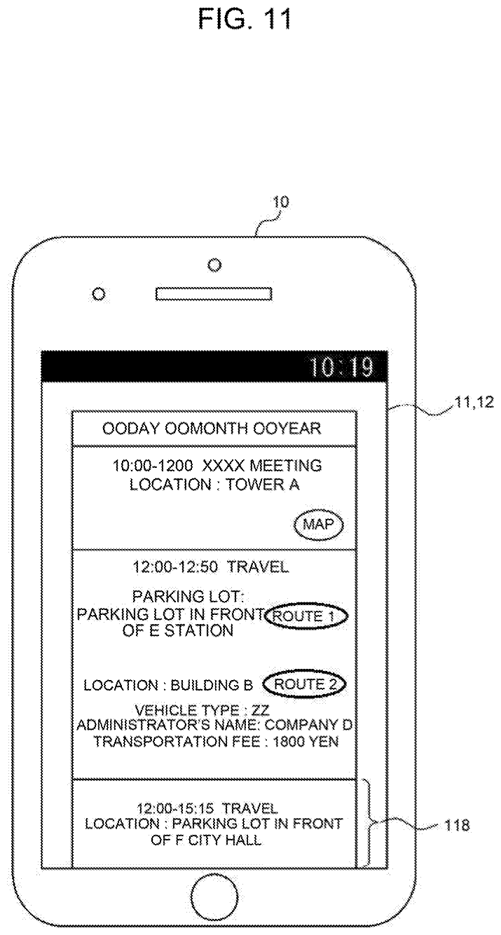

FIG. 11 illustrates an example of the schedule display screen after completion of the reservation when the server 20 searches for a route by which to return the vehicle. The schedule display screen shows a schedule (vehicle return schedule 118) for returning the vehicle. The vehicle return schedule 118 includes a place of return (a parking lot in front of F City Hall) and a time of return (15:15) of the vehicle based on a search result of the server 20. The user returns the vehicle to the place of return before the time of return, according to the vehicle return schedule 118, such that the vehicle can be used within the hours of use.

Further, the server 20 may acquire other information on the user in addition to the ID. For example, the server 20 may acquire membership information when the user starts to use the vehicle reservation system 1. The membership information may include information such as the user's name, ID, payment method, ownership of a driver's license, and the like. The membership information of each user can be stored in the server storage unit 22. Based on the user's membership information, the reservation unit 233 may determine whether to proceed with the vehicle reservation process. For example, when the user who does not own a drivel's license desires to use a shared or rental vehicle as a transport, the reservation unit 233 may cause the information processing apparatus 10 to display a warning or a message prompting confirmation, without instructing the administrator to execute the reservation.

In addition, the vehicle reservation system 1 may include an administrator, such as the external server 2. For example, the vehicle reservation system 1 may include a server that manages the dispatching of taxis and a server that manages shared or rental vehicles. Further, the administrator is not limited to the external server 2. For example, the administrator may be a device or an operator that takes reservations by voice dialogue. Here, the reservation unit 233 may call the administrator, and execute the reservation by voice dialogue. The voice data for the reservation may be stored in the server storage unit 22.

Further, a processor mounted on a general-purpose electronic device (corresponding to the information processing apparatus 10 and the server 20), such as a mobile information terminal and a server device, can function as the control limit 16 and the server control unit 23. Specifically, such a configuration can be realized by storing a program describing processing details for implementing each function of the electronic device in a storage (memory) of the electronic device, and reading and executing the corresponding program via a processor of the electronic device.

In addition, although the server 20 and the information processing apparatus 10 cooperatively execute the various processes in order to execute an automatic vehicle reservation, the manner in which the various processes are shared therebetween in the above embodiment is merely one example. For example, the information processing apparatus 10 may execute at least parts of the processes executed by the server 20 in the above embodiment. For example, die control unit 16 of the information processing apparatus 10 may execute the process that is executed by the information extraction unit 231 and the route search unit 232 in the above embodiment. In other words, the control unit 16 may search for a route to the destination based on the extracted destination, place of departure, time of departure, and the like, of travel. Here, the storage unit 15 may store at least a part of the schedule information 221 and the map information 222. Further, for example, the server 20 may execute at least pans of the processes that are executed by the information processing apparatus 10 in the above embodiment. For example, the server control unit 23 of the server 20 may execute the process that is executed by the schedule registration unit 161 in the above embodiment. In other words, the server control unit 23 may cause the information processing apparatus 10 to display the schedule registration screen, and acquire the user's activity schedule. Here, the schedule registration screen may be displayed on the browser by the server control unit 23 when the server 20 is accessed from the information processing apparatus 10 via the browser.

What is claimed is:

1. A vehicle reservation system comprising:
an information processing apparatus into which a user is able to input, as an activity schedule, a time range, a location, and a transport to travel to the location; and
a server that is able to communicate with the information processing apparatus,
wherein the server includes:
a server storage unit configured to acquire a plurality of activity schedules and store the plurality of activity schedules as schedule information in association with the user:
an information extraction unit configured to extract, from the schedule information, a first location and a transport included in a first activity schedule; and
a reservation unit configured to reserve the transport,
wherein the information extraction unit is configured to extract, from the schedule information, a second location and an end time of the time range included in a second activity schedule that takes place immediately prior to the first activity schedule, as a place of departure and a time of departure to travel to the first location, and
wherein the reservation unit is configured to reserve the transport with an administrator of the transport by outputting the first location as a destination, the place of departure and the time of departure to the administrator.

2. The vehicle reservation system according to claim 1, wherein the server includes:
a route search unit configured to search for a first route from the place of departure to a boarding position of the transport acquired from the administrator; and
an information update unit configured to generate a map showing the first route and cause the information processing apparatus to display the map.

3. The vehicle reservation system according to claim 2, wherein:
the route search unit is configured to further search for a second route from the boarding position to the destination, and calculate an estimated time of arrival at the destination; and
the information update unit is configured to cause the information processing apparatus to display at least one of the estimated time of arrival, a name of the administrator of the transport, and a transportation fee.

4. A vehicle reservation method executed by a server of a vehicle reservation system, wherein the vehicle reservation system includes an information processing apparatus into which a user is able to input, as an activity schedule, a time range, a location, and a transport to travel to the location, and the server that is able to communicate with the information processing apparatus, the method comprising:
acquiring a plurality of activity schedules and storing the plurality of activity schedules as schedule information in association with the user;
extracting, from the schedule information, a first location and a transport included in a first activity schedule;
extracting, from the schedule information, a second, location and an end time of the time range included in a second activity schedule that takes place immediately prior to the first activity schedule, as a place of departure and a time of departure to travel, to the first location; and
reserving the transport with an administrator of the transport by outputting the first location as a destination, the place of departure, and the time of departure to the administrator.

5. A non-transitory storage medium storing a program that causes a server of a vehicle reservation system to execute a process, wherein the vehicle reservation system includes an information processing apparatus into which a user is able to input, as an activity schedule, a time range, a location, and a transport to travel to the location, and the server that is able to communicate with the information processing apparatus, the process comprising:
acquiring a plurality of activity schedules and storing the plurality of activity schedules as schedule information in association with the user;
extracting, from the schedule information, a first location and a transport included in a first activity schedule;
extracting, from the schedule information, a second location and an end time of the time range included in a second activity schedule that takes place immediately prior to the first activity schedule, as a place of departure and a time of departure to travel to the first location; and
reserving the transport with an administrator of the transport by outputting the first location as a destination, the place of departure, and the time of departure to the administrator.
